(19) United States
(12) Patent Application Publication
(10) Pub. No.: US 2026/0127844 A1
(43) Pub. Date: May 7, 2026

(54) TRAINING AND UTILIZING LARGE LANGUAGE MODELS TO GENERATE GROUPS OF SEGMENTATION MASKS FOR DIGITAL IMAGES FROM VISION OR LANGUAGE INPUT FEATURES

(71) Applicant: Adobe Inc., San Jose, CA (US)

(72) Inventors: Zijun Wei, San Jose, CA (US); Shengcao Cao, Champaign, IL (US); Jason Wen Yong Kuen, Santa Clara, CA (US); Kangning Liu, San Jose, CA (US); Lingzhi Zhang, Philadelphia, PA (US); Jiuxiang Gu, College Park, MD (US); Hyun Joon Jung, Monte Sereno, CA (US)

(21) Appl. No.: 18/934,992

(22) Filed: Nov. 1, 2024

(51) Int. Cl. G06V 10/26; G06F 40/284; G06F 40/40; G06V 10/762; G06V 10/764; G06V 10/77; G06V 10/772; G06V 10/774

(52) U.S. Cl. CPC G06V 10/26; G06F 40/284; G06F 40/40; G06V 10/762; G06V 10/764; G06V 10/7715; G06V 10/772; G06V 10/774

(57) ABSTRACT

The present disclosure relates to systems, non-transitory computer-readable media, and methods for grouping segmentation masks from digital images. The disclosed system generates, utilizing a segmentation model, a set of candidate segmentation masks for objects portrayed in a digital image. In addition, the disclosed system generates, utilizing a mask projector model, a set of mask tokens from the set of candidate segmentation masks. Moreover, the disclosed system selects, utilizing a large language model, a group of segmentation masks from the set of candidate segmentation masks based on the set of mask tokens, wherein the group of segmentation masks satisfies a mask group classification threshold. Further, the disclosed system provides, for display via a client device, the group of segmentation masks for the digital image.

### BACKGROUND

Recent years have seen significant improvements in hardware and software platforms for image segmentation. For example, conventional systems utilize computer-implemented models to extract a mask for a visual entity portrayed in a digital image. To illustrate, some conventional systems can utilize machine learning approaches, such as convolutional neural networks, to detect an entity and select pixels in the image that correspond to the detected entity. However, such conventional systems have a number of technical deficiencies with regard to accuracy, flexibility, and efficiency of implementing computing devices.

### BRIEF SUMMARY

Embodiments of the present disclosure provide benefits and/or solve one or more of the foregoing or other problems in the art with systems, non-transitory computer-readable media, and methods for training and utilizing a group segmentation machine learning model to generate groups of segmentation masks for digital images from input vision or language features. To illustrate, in one or more implementations, the disclosed systems utilize a segmentation model to generate a pool of candidate masks for a digital image and utilize a large language model to intelligently select a group of related masks from the pool. In some examples, the disclosed systems select a group of masks using one or more computer vision and/or natural language features. To illustrate, the disclosed systems receive a natural language input and/or a reference mask from a client device and convert these inputs to tokens for utilization in a large language model. For example, in some implementations the disclosed systems select a group of masks by utilizing projector models to generate mask tokens associated with the pool of candidate masks, text tokens associated with a natural language input, and/or reference mask tokens associated with pertinent computer vision features. In one or more embodiments, the disclosed systems process these various tokens with a large language model to generate and provide various multi-modal responses to client devices, including groups of related masks and/or natural language responses. By grouping masks using computer vision and natural language, the disclosed systems can realize improved accuracy, efficiency, and flexibility for image segmentation tasks and higher practicality for various segmentation applications.

As mentioned, in some implementations the disclosed systems also train a group segmentation machine learning model to generate groups of segmentation masks for individual digital images. For example, the disclosed systems generate a group mask extraction training dataset for training a mask grouping model. To illustrate, the disclosed systems identify an image dataset, generate candidate masks for the image dataset (utilizing a segmentation model), generate dense descriptions for the candidate masks (utilizing a multi-modal large language model), and generate training mask groups with explanations (utilizing an additional large language model). In one or more implementations, the disclosed systems utilize this annotation pipeline to generate an image dataset for scalable and low-computational cost training data generation. Moreover, in some embodiments the disclosed systems utilize the training dataset to modify parameters of the group segmentation machine learning model for improved accuracy in generating groups of segmentation masks for individual digital images from various multi-modal inputs.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a mask group system operates in accordance with one or more embodiments.

FIG. 2 illustrates generating a group of segmentation masks utilizing a mask grouping model in accordance with one or more embodiments.

FIG. 3 illustrates an example architecture of a mask grouping model generating a group of segmentation masks from a digital image and multi-modal inputs in accordance with one or more embodiments.

FIG. 4 illustrates an annotation pipeline for generating a group mask extraction training dataset in accordance with one or more embodiments.

FIG. 5 illustrates training a mask grouping model in accordance with one or more embodiments.

FIG. 6 illustrates a diagram of an example architecture of the mask group system in accordance with one or more implementations.

FIG. 7 illustrates a flowchart of a series of acts for grouping segmentation masks in accordance with one or more embodiments.

FIG. 8 illustrates a block diagram of an example computing device for implementing one or more embodiments of the present disclosure.

### DETAILED DESCRIPTION

One or more embodiments of the present disclosure include a mask group system that trains and utilizes a group segmentation machine learning model to generate groups of segmentation masks for digital images from input vision or language features. For example, the mask group system utilizes a segmentation machine learning model to generate a pool of candidate segmentation masks for a digital image and utilize a large language model to select a group of related segmentation masks from the pool. Specifically, in one or more embodiments the mask group system utilizes projector models to generate various tokens from various input modalities, such as language input or reference masks selected by a client device. In some implementations, the mask group system then analyzes these tokens utilizing a large language model to generate groups of segmentation masks and/or natural language text responses. In one or more embodiments, the mask group system provides a selected group of segmentation masks and/or a client response text to a client device. For example, the client response text can identify the selected segmentation masks, explain the relation between the selected segmentation masks (e.g., the client response text may indicate a mask group classification threshold and/or that each mask in the selected group satisfies the mask group classification threshold), and/or provide a response to a natural language input from the client device.

In some examples, the mask group system generates groups of segmentation masks using one or more computer vision input features. For example, the mask group system receives an indication of one or more reference masks or reference images. The mask group system selects a group of segmentation masks based on the indication. To illustrate, the mask group system analyzes features of a reference mask and selects segmentation masks from the pool of candidate segmentation masks based on the features of the reference mask.

Moreover, in some implementations the mask group system groups segmentation masks using one or more natural language input features. For example, the mask group system selects segmentation masks according to a natural language input from a client device. As an illustrative example, the natural language input can indicate a feature or characteristic of a group (e.g., a category, an attribute, a position, and the like), and the mask group system can generate a group of segmentation masks that satisfy the feature or characteristic.

In one or more implementations, the mask group system generates groups of segmentation masks without receiving computer vision features or natural language features. For example, the mask group system analyzes the pool of candidate segmentation masks and intelligently determines a group of segmentation masks based on underlying characteristics or features from the digital image. Accordingly, in one or more implementations the mask group system generates and provides a group of segmentation masks grouped by an automatically determined classification or feature.

As mentioned, in one or more implementations, the mask group system utilizes a mask grouping model that itself includes various component models. For example, the mask group system utilizes a group segmentation machine learning model that includes one or more of a segmentation model, a mask projector model, a large language model, a classification model, a text tokenizer, and/or a visual backbone model. To illustrate, the mask group system utilizes a segmentation model to generate a pool of candidate masks from a digital image. Moreover, the mask group system utilizes one or more visual backbone models to generate global visual tokens for all or part of a digital image (e.g., for the digital image globally or for a reference mask from the digital image).

For instance, in some implementations, the mask group system utilizes a mask projector model to generate a set of mask tokens from the set of candidate masks and/or one or more reference mask tokens from a reference mask. For example, the mask projector model can convert a localized candidate mask feature map generated by visual backbone models into a mask token. In some implementations, the mask group system utilizes a text tokenizer to convert natural language input into text tokens.

Furthermore, in one or more embodiments, the mask group system utilizes the large language model to analyze one or more of the text tokens, the mask tokens, the global visual tokens, and/or the reference mask token(s) to select a group of segmentation masks. In some examples, the mask group system utilizes the large language model to generate a hidden feature representation for each candidate mask from the various input tokens. Moreover, the mask group system utilizes a classification model to analyze the hidden feature representation and generate a group classification (e.g., a binary classification of whether to include the mask in a group of segmentation masks to surface to a client device). To illustrate, the mask group system utilizes the classification model to generate a probability prediction and compares the probability prediction to a classification threshold.

As mentioned previously, in some implementations, the mask group system also trains a mask grouping model. For instance, the mask group system utilizes the mask grouping model to generate predicted groups of masks (from training digital images and candidate masks) and modifies parameters of component architectures of the mask grouping machine learning model by comparing the predicted groups of masks to ground truth mask groups. In one or more embodiments the mask group system also utilizes a series of machine learning approaches in an annotation pipeline to generate a group mask extraction training dataset and then utilizes the group mask extraction training dataset to modify parameters of the mask grouping model.

As an illustrative example, the mask group system identifies or receives an image dataset (e.g., the mask group system can receive the image dataset from a third-party server or device). In some cases, the mask group system filters the image dataset. For instance, the mask group system extracts/detects a quantity of objects in an image and includes the image in the dataset if the detected quantity of objects satisfies a threshold quantity of objects.

Moreover, in some implementations, the mask group system uses a segmentation model, multi-modal language model, and one or more additional large language models to generate the group mask extraction training dataset from the filtered images. For example, the mask group system uses a segmentation model to generate segmentation masks for the image dataset. Moreover, the mask group system uses a multimodal large language model to generate dense descriptions for the segmentation masks. In some cases, the mask group system filters the masks and/or the dense descriptions, for example, by comparing a generated mask or description to a ground truth mask or description and eliminating masks or descriptions that fail to satisfy a threshold accuracy for the description or mask. In addition, for any particular image in the image dataset, the mask group system uses a large language model to generate training mask groups with associated explanations. In this manner, the mask group system can create a training dataset (e.g., a dataset including an image dataset, candidate segmentation masks, dense descriptions, and mask groups with explanations) and train the mask grouping model using the training dataset.

Conventional systems that generate segmentation masks have a number of technical deficiencies with regard to accuracy, flexibility, and efficiency. For example, while some conventional systems can create a segmentation mask for an object, these systems lack operational flexibility and accuracy in aligning segmentation masks to client device queries/requests. More specifically, conventional systems rigidly generate isolated segmentation masks and rely on interactions at client devices to arrange, organize, relate, and modify segmentation masks in generating modified digital images. Although generating individual masks can allow client devices to manipulate digital objects portrayed in a digital image, such an approach fails to flexibly adapt to the individualized requests of particular client devices. Furthermore, conventional systems are also tied to analyzing a rigid category of input information and generating a rigid type of response. For example, conventional systems analyze input digital images and generate a segmentation mask for the digital image.

Conventional systems also suffer from computational inefficiencies. For example, due to the inflexibilities and inaccuracies just discussed conventional systems often require increased time, user interfaces, and user interactions with client devices (leading to reduced computational efficiency or increased latency). Indeed, by generating individual segmentation masks, conventional systems often require significant user interactions to identify and then modify related objects portrayed in digital images. Additionally, conventional systems lack sufficient training datasets to improve the deficiencies discussed above. Indeed, generating more robust training datasets to improve accuracy and flexibility issues utilizing conventional approaches would require a prohibitive amount of time, computational resources, and bandwidth.

The mask group system provides a number of advantages relative to conventional systems in improving operational flexibility, accuracy, and efficiency of implementing computing devices. For example, in some embodiments the mask group system provides improved functionality to implementing computers by generating groups of related segmentation masks. Moreover, in some implementations, the mask group system dynamically generates these groups of segmentation masks based on a variety of different modality inputs from client devices. By utilizing a mask grouping machine learning model that includes a large language model capable of processing tokens reflecting language, vision, or other input features, in one or more implementations the mask group system flexibly generates groups of segmentation masks. In addition, in some implementations, the mask group system generates a variety of different responses to client devices, including group segmentation masks and client text responses that provide additional context to the group segmentation masks.

Moreover, in some implementations the mask group system also improves accuracy of implementing computing devices. Indeed, by utilizing the mask grouping machine learning model, in one or more implementations, in one or more embodiments the mask group system accurately generates groups of segmentation masks that align to the particular queries/requests of individual client devices, including language queries, reference masks queries, or other input modalities. Thus, in one or more embodiments the mask group system accurately generates groups of segmentation masks based on varied inputs of client devices.

Further, in one or more embodiments, the mask group system improves efficiency relative to conventional systems. In particular, in some implementations the mask group system improves computational efficiency and reduces latency for image editing by generating and providing groups of related segmentation masks with relatively few client device interactions or user interfaces compared to conventional systems. Further, the mask group system provides a scalable, cost-effective data generation pipeline to create a robust and diverse training dataset capable of training mask grouping machine learning models.

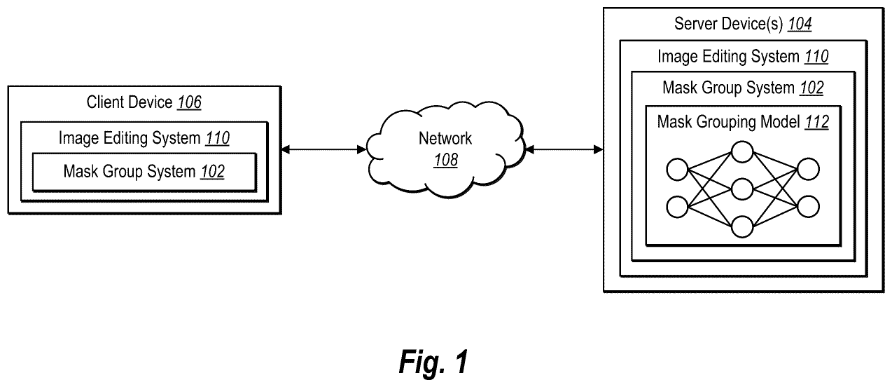

Turning now to the figures, FIG. 1 includes an embodiment of a system environment 100 in which a mask group system 102 is implemented. In particular, the system environment 100 includes server device(s) 104 and a client device 106 in communication via a network 108. Moreover, as shown, the server device(s) 104 includes an image editing system 110, which includes the mask group system 102. Furthermore, the client device 106 includes the image editing system 110 (and the mask group system 102).

As shown in FIG. 1, the client device 106 or the server device(s) 104 include or host the image editing system 110. The image editing system 110 includes, or is part of, one or more systems that implement digital image generation or editing operations. For example, the image editing system 110 provides tools for generating or editing digital images involving the use of various layers and masks. To illustrate, the image editing system 110 communicates with the client device 106 via the network 108 to provide the tools for display and interaction via the image editing system 110 at the client device 106. Additionally, in some embodiments, the image editing system 110 receives requests to access digital image data stored (e.g., at the server device(s) 104 or at another device such as a database) and/or requests to store digital image data. In some embodiments, the image editing system 110 receives interaction data for viewing or performing various image processing operations and provides the results of the interaction data (e.g., generated digital image data) for display via the image editing system 110 or to a third-party system.

According to one or more embodiments, the image editing system 110 utilizes the mask group system 102 to generate groups of segmentation masks from input vision or language features. In particular, the mask group system 102 generates a set of candidate segmentation masks for entities in a digital image. The mask group system 102 generates a set of mask tokens from the set of candidate segmentation masks. The mask group system 102 selects a group of segmentation masks based on the mask tokens. Accordingly, the mask group system 102 provides the group of segmentation masks for display via the client device 106. In some examples, the mask group system 102 utilizes one or more features (e.g., computer vision features and/or language features) to select the group of segmentation masks utilizing the mask grouping model 112. Additionally or alternatively, the mask group system 102 can perform one or more training operations as described herein to generate a training data set and/or train one or more mask grouping model 112 of the mask group system 102.

As illustrated in FIG. 1, the mask group system 102 is implemented on the client device 106 or on the server device(s) 104. In particular, in some implementations, the mask group system 102 on the server device(s) 104 supports the mask group system 102 on the client device 106. For instance, the server device(s) 104 generates or obtains the mask group system 102 for the client device 106 (e.g., as part of a software application or suite). The server device(s) 104 provides the mask group system 102 to the client device 106 for performing digital image generation/editing processes at the client device 106. In other words, the client device 106 obtains (e.g., downloads) the mask group system 102 from the server device(s) 104. At this point, the client device 106 is able to utilize the mask group system 102 to generate/edit digital images independently from the server device(s) 104.

In additional embodiments, although FIG. 1 illustrates the server device(s) 104 and the client device 106 communicating via the network 108, the various components of the system environment 100 communicate and/or interact via other methods (e.g., the server device(s) 104 and the client device 106 communicate directly). Furthermore, although FIG. 1 illustrates the mask group system 102 being implemented by a particular component and/or device within the system environment 100, the mask group system 102 is implemented, in whole or in part, by other computing devices and/or components in the system environment 100. For example, in some embodiments, the server device(s) 104 include or host the image editing system 110 and/or the mask group system 102.

To illustrate, the image editing system 110 includes a web hosting application that allows the client device 106 to interact with content and services hosted on the server device(s) 104 (e.g., in a software as a service implementation). To illustrate, in one or more implementations, the client device 106 accesses a web page supported by the server device(s) 104. The client device 106 provides input to the server device(s) 104 to view information for layers and/or masks and, in response, the mask group system 102 or the image editing system 110 on the server device(s) 104 performs operations to generate segmentation masks, generate or select a group of segmentation masks that are related (e.g., masks that satisfy a mask group classification threshold based on one or more language or computer vision features), or both, among other examples of image editing operations. The server device(s) 104 provide the output or results of the operations to the client device 106.

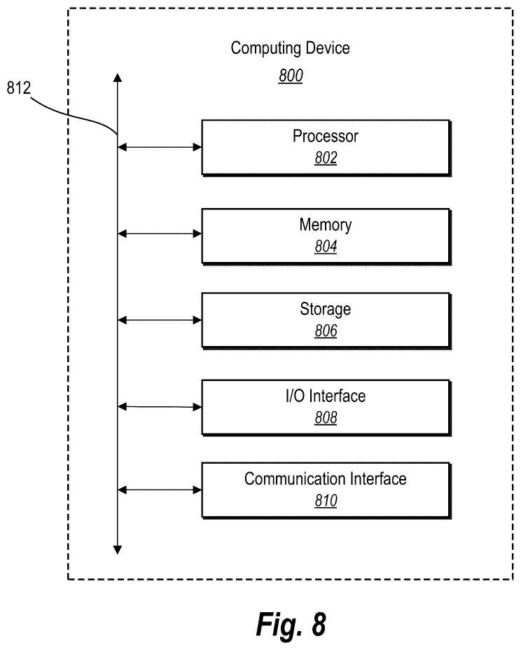

In one or more embodiments, the server device(s) 104 include a variety of computing devices, including those described below with reference to FIG. 8. For example, the server device(s) 104 includes one or more servers for storing and processing data associated with image generation and editing. In some embodiments, the server device(s) 104 also include a plurality of computing devices in communication with each other, such as in a distributed storage environment. In some embodiments, the server device(s) 104 include a content server. The server device(s) 104 also optionally include an application server, a communication server, a web-hosting server, a social networking server, a digital content campaign server, or a digital communication management server.

In addition, as shown in FIG. 1, the system environment 100 includes the client device 106. In one or more embodiments, the client device 106 includes, but is not limited to, a mobile device (e.g., smartphone or tablet), a laptop, a desktop, including those explained below with reference to FIG. 8). Furthermore, although not shown in FIG. 1, the client device 106 is operable by a user (e.g., a user included in, or associated with, the system environment 100) to perform a variety of functions. In particular, the client device 106 performs functions such as, but not limited to, accessing, viewing, generating, and editing digital images. In some embodiments, the client device 106 also performs functions for generating, capturing, or accessing data to provide to the image editing system 110 and the mask group system 102 in connection with editing digital images. For example, the client device 106 communicates with the server device(s) 104 via the network 108 to provide information (e.g., user interactions) associated with digital images. Although FIG. 1 illustrates the system environment 100 with a single client device, in some embodiments, the system environment 100 includes a different number of client devices.

Additionally, as shown in FIG. 1, the system environment 100 includes the network 108. The network 108 enables communication between components of the system environment 100. In one or more embodiments, the network 108 may include the Internet or World Wide Web. Additionally, the network 108 optionally include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server device(s) 104 and the client device 106 communicates via the network using one or more communication platforms and technologies suitable for transporting data and/or communication signals, including any known communication technologies, devices, media, and protocols supportive of data communications, examples of which are described with reference to FIG. 8.

In some embodiments, the mask group system 102 on the server device(s) 104 supports the mask group system 102 on the client device 106. For instance, in some cases, the mask group system 102 on the server device(s) 104 generates or learns parameters for one or more machine learning models (e.g., the mask grouping model 112). The factual inconsistency detection system 106 then, via the server device(s) 104, provides the one or more trained machine learning models to the client device 106. In other words, the client device 106 obtains (e.g., downloads) the one or more machine learning models (e.g., with any learned parameters) from the server device(s) 104. Once downloaded, the one or more machine learning models on the client device 106 utilizes the one or more trained machine learning models to generate groups of segmentation masks from digital images independent from the server device(s) 102. In some implementations, the client device 106 trains the one or more machine learning models.

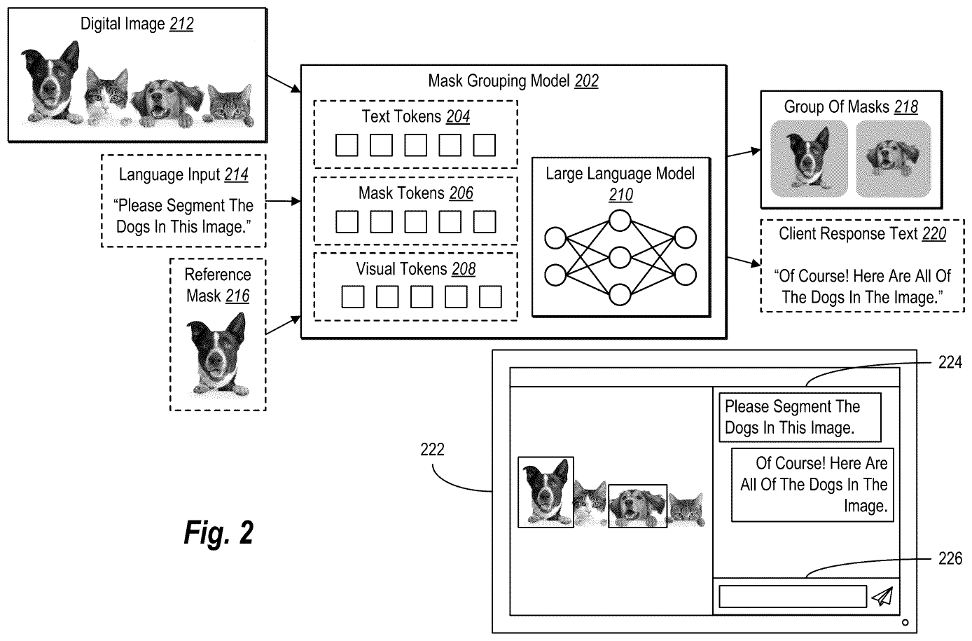

As discussed above, the mask group system 102 can identify groups of related segmentation masks, for example, utilizing computer vision features, natural language features, or both. For instance, FIG. 2 illustrates the mask group system 102 generating a group of segmentation masks utilizing a mask grouping model in accordance with one or more embodiments. In particular, as described in more detail below, the mask group system 102 utilizes a mask grouping model 202 to intelligently and accurately generate a group of masks 218 for a digital image 212.

For instance, the mask group system 102 can be implemented for one or more image segmentation functions of the image editing system 110. Image segmentation can be an example of a fundamental computer vision task. As an illustrative example, a device implementing the image editing system 110 decomposes an image input into semantically coherent regions corresponding to visual entities such as objects, faces, categories, backgrounds, errors or discrepancies in pixels of the photo, and the like. The computer vision task of identifying and/or understanding objects in the image input enables various applications like image editing. However, conventional systems for image segmentation lack semantic-rich understanding (e.g., language capabilities) which results in weak practical value of such tools, for example, for application scenarios where natural language instructions or criteria are more flexible, intuitive, and/or efficient.

Accordingly, the mask group system 102 beneficially enables segmentation applications to select a group of masks 218 from a pool according to one or more features of a prompt (e.g., language features, computer vision features, both language and computer vision features, or an empty prompt). By understanding such features (e.g., criteria) and proposing mask groups that correspond to or satisfy the features, the mask group system 102 provides improved flexibility and efficiency to image editing applications.

A segmentation mask includes a portion of an image (e.g., one or more pixels) that correspond to a visual entity in the image, such as an object, person, or background. To illustrate, a segmentation mask can include a boundary (e.g., pixels within the boundary are pixels included in the segmentation mask), a set of pixels, or a map (e.g., a binary map), identifying a visual entity in a digital image. “Segmentation mask,” “mask,” and “segmentation” can be used interchangeably herein.

As illustrated in FIG. 2, the mask group system 102 utilizes a mask grouping model 202 to generate a group of masks 218 from one or more inputs, including a digital image 212, a language input 214, or a reference mask 216. The mask group system 102 receives, identifies, generates, or otherwise determines one or more inputs. In some examples, the one or more inputs are included in a prompt or query. For example, a client device can submit one or more queries to the mask grouping model 202 that indicates the language input 214, the reference mask 216, and/or the digital image 212.

As shown in FIG. 2, the mask group system 102 can utilize the mask grouping model 202 to analyze the digital image 212. The digital image 212 can include a digital file comprising visual content. For instance, the digital image 212 can include a raster image or vector image portraying one or more entities. That is, the digital image 212 depicts a quantity of objects (e.g., people, animals, shapes, items, structures, areas, faces, features, backgrounds, errors or discrepancies, or other examples of entities or objects).

In addition, as shown in FIG. 2, the mask group system 102 can utilize the mask grouping model 202 to analyze a language input 214. The language input 214 can include a request, instructions, prompt, or text. For example, the language input 214 indicates a mask grouping feature such as a category (e.g., vehicles, people, animals, a type of an object, the background, the foreground), a quantity of desired masks to be included in a group, an attribute (e.g., a color, a type of material such as metal, a size, a shape), a position (e.g., left side of the image), or other examples of grouping features. In some examples, the language input 214 indicates multiple features in multiple inputs or in a single input (e.g., “white vehicles”), which enables the mask grouping model 202 to output more general and/or complex grouping of masks based on the language input 214. As an illustrative example, the language input 214 includes the text “please segment the dogs in this image.”

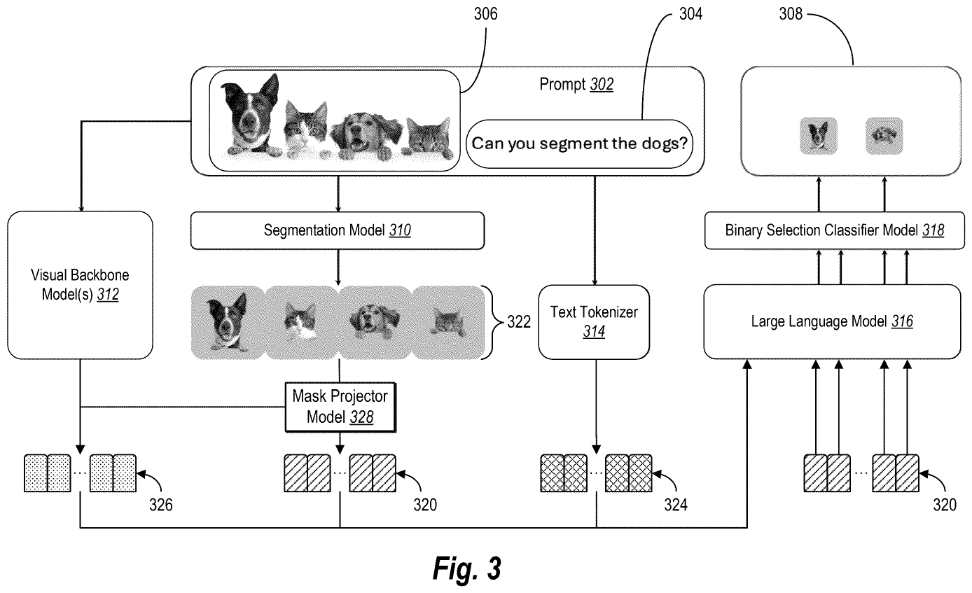

In addition, the mask group system 102 can utilize the mask grouping model 202 to analyze a computer vision feature (e.g., a computer vision input, a computer vision criteria). For example, the mask grouping model 202 receives, accesses, or identifies a reference mask 216. As will be described below in further detail with reference to FIG. 3, the mask grouping model 202 utilizes the reference mask 216 as a feature for selecting a group of masks from a pool of candidate masks. As an illustrative example, the client device indicates the reference mask 216 (e.g., a mask of a dog) and the mask grouping model 202 identifies a feature associated with the reference mask 216 (e.g., the mask grouping model 202 can determine that the reference mask 216 has a feature or characteristic of being a dog, an animal, in motion, brown, etc.). The mask grouping model 202 selects masks in the digital image 212 that satisfy a threshold correlation to the feature of the reference mask 216 (e.g., the mask grouping model 202 can determine that the reference mask 216 has a category of “dog” and select other masks with a category of “dog,” although any level of granularity, such as an “animal” or a specific breed of dog, or any other type of grouping feature can be used). In some examples, the client device provides the reference mask 216. For example, a client device selects a mask or an area in the digital image 212 (or another digital image) to provide as the reference mask 216. As an illustrative example, the client device selects one of the dogs in the digital image 212 as the reference mask 216.

In one or more implementations, the mask group system 102 utilizes the mask grouping model 202 to generate the group of masks 218 without receiving a language input 214 or a reference mask 216. Stated alternatively, the mask grouping model 202 can receive an “empty” prompt (e.g., a prompt that includes the digital image 212 without the language input 214 or the reference mask 216). In such implementations, the mask grouping model 202 selects the group of masks 218 by analyzing the pool of candidate segmentation masks and intelligently determining a group of masks 218 based on underlying characteristics or features from the digital image 212. As an illustrative example of an automatically determined classification or feature, the mask grouping model 202 analyzes a digital image 212 containing a series of animals and suggests a group of masks 218 that selects a group of the animals based on a species (e.g., dogs in the digital image 212). The mask grouping model 202 can utilize a variety of features, characteristics, or categories to generate the group of masks 218. In some implementations, the mask grouping model determines common features, characteristics, or categories of the masks in the group of masks 218 and generates a client response text 220 that identifies or explains the features, characteristics or categories (e.g., the client response text 220 indicates that the group of masks corresponds to dogs in the digital image 212 as a suggestion of a grouping feature). As an illustrative example, the client response text 220 recites “Of course! Here are all of the dogs in the image.”

The mask grouping model 202 can include one or more models, including machine learning models. For example, a machine learning model includes a computer algorithm or a collection of computer algorithms that automatically improve for a particular task through iterative outputs or predictions based on use of data. To illustrate, a machine learning model utilizes one or more learning techniques to improve in accuracy and/or effectiveness. Example machine learning models include various types of neural networks, decision trees, support vector machines, linear regression models, and Bayesian networks.

Along these lines, a neural network refers to a machine learning model that is trained and/or tuned based on inputs to generate digital content such as text and images, and to determine classifications, scores, or approximate unknown functions. For example, a neural network includes a model of interconnected artificial neurons (e.g., organized in layers) that communicate and learn to approximate complex functions and generate outputs (e.g., information flow patterns) based on a plurality of inputs provided to the neural network. In some cases, a neural network refers to an algorithm (or set of algorithms) that implements deep learning techniques to model high-level abstractions in data. In some embodiments, a neural network includes various layers such as an input layer, one or more hidden layers, and an output layer that each perform tasks for processing data. For example, a neural network includes a deep neural network, a convolutional neural network, a recurrent neural network (e.g., an LSTM), a graph neural network, a transformer neural network, a diffusion neural network, a multi-scale attention network, or a large language model.

For example, the mask grouping model can include a machine learning model that generates a group of segmentation masks from a digital image. In some implementations, the mask grouping model includes a variety of sub-models. For example, the mask grouping model 202 can include a segmentation model, a mask projector model, a text tokenizer, a visual backbone model, a classification model, a large language model 210, a large multi-modal model, or any combination of these models or other models. In particular, the mask group system 102 can utilize the segmentation model to identify candidate segmentation masks, utilize the mask projector model to generate tokens from candidate or reference segmentation masks, utilize the text tokenizer to generate tokens from input text, and utilize the large language model 210 in combination with the classification model to classify segmentation masks into a group of related segmentation masks.

For example, as shown in FIG. 2, the mask grouping model 202 can include the large language model 210. The large language model 210 can be a model that can process, understand, and generate human language (e.g., natural language). The large language model 210 can be trained on a training dataset to tune parameters of a neural network to accurately process, interpret, understand, and generate language. In particular, a large language model includes a machine learning model that utilizes a transformer architecture to identify patterns, relationships and context within text.

As an illustrative example of selecting a group of masks 218, the mask grouping model 202 receives the digital image 212 portraying a set of objects. Additionally, the mask grouping model 202 receives a natural language input 214 (e.g., a set of instructions), a reference mask 216 (e.g., a set of pixels corresponding to an object in the digital image 212 or another object in a different image), or both. The mask grouping model 202 utilizes a segmentation model to generate a set of candidate masks for the digital image 212. For example, the mask grouping model 202 generates a “pool” of masks corresponding to respective objects in the digital image 212 from which the mask grouping model 202 can select the group of masks 218 based on one or more language or computer vision features.

The mask grouping model 202 generates, utilizing the one or more models, the text tokens 204, the mask tokens 206, and/or the visual tokens 208. In one or more embodiments, the text tokens 204 can correspond to (e.g., represent) the language in the language input 214, the mask tokens 206 can correspond to the set of candidate segmentation masks, and the visual tokens 208 can correspond to portions of the digital image 212, the reference mask 216, or both. For example, the mask grouping model 202 generates the text tokens 204 from the words in the language input 214 using a text tokenizer model, mask tokens 206 from the set of candidate masks using a mask projector model, and the visual tokens 208 using one or more global visual backbone models, as described with further detail in FIG. 3. The term “token” can indicate a unit of data that is processed by a large language model. For example, a token can include a representation of words, characters, sentences, or other aspects of a sentence.

Tokens can also include representations of other inputs (e.g., visual representations projected to a language token space or format). A large language model can utilize tokens as input to predict a next token and/or generate an output, analyzing the relationships between the tokens to understand and produce coherent language or accurate predictions.

For example, a “text token” can be a word token (e.g., each word corresponds to a respective token processed by a model), a sub-word token (e.g., a portion of a word corresponds to a first token and a second portion of the word corresponds to a second token), a phrase token (e.g., a token corresponds to a phrase of multiple words), a character token (e.g., individual characters within a word correspond to a respective token), and the like. As another example, an “image token” can include a representation of pixels, segments of an image, masks, or other visual features that can be processed by a large language model.

The mask grouping model 202 selects a group of masks 218 from the set of candidate masks utilizing the text tokens 204, the mask tokens 206, and the visual tokens 208. In some implementations, the mask grouping model 202 generates a hidden feature representation for each candidate mask using the various tokens and utilizes a classification model to select candidate masks to include in the group of masks 218. The mask grouping model 202 provides the group of masks 218 for display on a client device. The client device can select, modify, edit, or adjust the group of masks 218, among other examples of image editing operations.

In some implementations, the mask grouping model 202 generates client response text 220. For example, the mask grouping model 202 generates a response to the language input 214 and provides the response (e.g., the client response text 220) to the client device. Providing client response text 220 can provide an interactive and intuitive process for image segmentation and editing. For example, the mask grouping model 202 can receive further language input 214 (e.g., in response to the client response text 220) and perform further or different mask grouping operations in accordance with the further language input 214. As an illustrative example, a client device can input a second instance of language input 214 in the text prompt box 226 in response to a client response text 220 indicates different and/or additional features (e.g., to group masks based on different features or characteristics, a different quantity of masks, etc.), indicates to remove one or more features from the initial language input 214, or both. The mask grouping model 202 utilizes the first language input 214 and/or the second language input 214 to select a second group of masks 218 different than a previously selected group of masks 218. Such an interactive process can be repeated any quantity of times.

In some embodiments, the mask group system 102 provides the group of masks 218, the client response text 220, or both for display on a client device. For example, the user interface 222 is an example of a user interface of an image editing application as described herein with reference to FIG. 1. The user interface 222 can display the digital image 212, a conversion display 224, a text prompt box 226, and/or the group of masks 218 of the digital image 212. The conversion display 224 includes the language input 214 and the client response text 220. Although the segmentation masks for the dogs in the digital image 212 are depicted as dashed boxes for illustrative clarity, the segmentation masks can be refined and/or more accurate (e.g., each pixel belonging to a dog can correspond to a segmentation mask).

In some implementations, the mask group system 102 also modifies the digital image utilizing the group of masks 218. For example, based on additional user interaction, the mask group system 102 can crop (e.g., remove) the group of masks 218 or replace pixels of the digital image outside of the group of masks 218. To illustrate, the mask group system 102 can move the group of masks 218 to a new image (e.g., a new background from a separate digital image). Similarly, the mask group system 102 can replace the group of masks 218 with new digital content (e.g., a new set of dogs) or otherwise modify the digital image based on the group of masks 218 (e.g., highlight, lighten, or modify the group of masks 218).

As mentioned above, the mask group system 102 utilizes one or more models to generate an output group of segmentation masks based on computer vision or natural language features. For example, FIG. 3 illustrates an example architecture of a mask grouping model generating a group of segmentation masks from a digital image and multi-modal inputs in accordance with one or more embodiments. Specifically, FIG. 3 illustrates the mask group system 102 receiving a prompt 302 including or corresponding to a digital image 306. Moreover, FIG. 3 illustrates the mask group system 102 identifying a group of segmentation masks 308.

As shown, the prompt 302 includes the digital image 306 (e.g., the digital image 212 as described with reference to FIG. 2). In some embodiments, the prompt 302 includes a natural language input 304. The natural language input 304 is communicated from a client device. For example, the client device can indicate segmentation features (e.g., criteria) in a natural language format. In this illustrative example, the natural language input 304 indicates that the mask group system 102 should identify and select a type of object in the image (e.g., text that states “can you segment the dogs?” indicating that the client device desires a segmentation mask for each dog in the digital image 306). Additionally or alternatively, the prompt 302 includes a reference mask feature. For example, the prompt 302 indicates a selected set of pixels in the digital image 306 that correspond to a reference object. In some other embodiments, the prompt 302 can have an “empty prompt” s described with reference to FIG. 2.

The mask group system 102 selects the group of segmentation masks 308 based on one or more features of the prompt 302 (e.g., computer vision features such as a reference mask, natural language features from the language input 304, both, or an “empty prompt,” as described with reference to FIG. 2.). The exemplary architecture of the mask group system 102 can enable the mask group system 102 to interpret, understand, and apply the features of the prompt 302 to the selection of the group of segmentation masks 308.

As shown in FIG. 3, in one or more embodiments, the architecture of a mask grouping model includes a set of models. The set of models includes a segmentation model 310, a visual backbone model 312, a text tokenizer 314, a large language model 316, and a binary selection classifier model 318.

As an illustrative example of generating a group of segmentation masks 308, the mask group system 102 can receive the digital image 306. The digital image 306 includes a quantity of objects (e.g., the digital image 306 portrays four animals that include two dogs and two cats). The prompt 302 includes a natural language input 304. In some embodiments, the prompt 302 includes a reference mask feature. For example, the prompt 302 indicates a portion of the digital image 306 that corresponds to one of the dogs (e.g., a segmentation mask generated by the segmentation model or selected by a client device).

The segmentation model 310 segments the digital image 306. Stated alternatively, the segmentation model 310 generates the set of candidate segmentation masks 322 from the digital image 306 utilizing the segmentation model 310. For example, the segmentation model 310 generates a respective segmentation mask for each object in the digital image 306. The segmentation model 310 can be a model that produces a set of masks from an image (e.g., the model can identify objects in the image and generate segmentation masks that cover the features or pixels corresponding to each object). In some examples, the segmentation model 310 performs classification tasks for each pixel in an image (e.g., classifying the pixel as belonging to an object or having a characteristic such as a type of object, a feature or attribute, etc.). In some examples, the segmentation model 310 can be an example of an open-world segmentation model or a referring segmentation model. The segmentation model can include a pre-trained convolutional neural network for generating segmentation masks from digital images.

To illustrate, the segmentation model 310 generates a first segmentation mask for a first dog in the digital image 306, a second segmentation mask for a second dog in the digital image 306, a third segmentation mask for a first cat in the digital image 306, and a fourth segmentation mask for a second cat in the digital image 306, although it is to be understood that any quantity or type of objects and corresponding segmentation masks can be used. The segmentation masks 322 can be referred to as a “pool” of candidate segmentation masks. The segmentation masks 322 can be a higher quantity of segmentation masks for the objects in the digital image 306 from which the large language model 316 and the binary selection classifier model 318 selects the group of segmentation masks 308.

As shown in FIG. 3, The mask group system 102 generates mask tokens 320 using a mask projector model 328. The mask projector model 328 includes a computer-implemented algorithm for generating tokens from a segmentation mask. In particular, the mask projector model 328 includes a machine learning model trained to project segmentation masks (or vector representations of segmentation masks) into a tokenized format capable of being analyzed by a large language model. For example, the mask projector model 328 can include a feedforward artificial neural network, such as a two-layer multilayer perceptron.

To illustrate, with regard to FIG. 3, the mask projector model 328 tokenizes the masks 322 into individual elements that can be utilized by the large language model 316. For example, the mask projector model 328 aggregates visual features within the mask for each of the masks 322 (e.g., utilizing a visual feature map extracted by the visual backbone model(s) 312). Thus, the mask projector model 328 generates a localized candidate mask feature map for a candidate mask 322. For instance, the mask projector model 328 down-samples a mask to a same spatial size as the visual feature map produced by a visual backbone model 312. The mask projector model 328 averages the visual features within the down sampled mask to produce a “mask-level” feature. A mask-level feature can be features associated with a mask of the segmentation masks 322. The mask projector model 328 (e.g., a lightweight mask projector) converts the mask-level feature into the language feature space. For example, the mask projector model 328 generates a “token” as described herein with reference to FIG. 2 that corresponds to a respective mask of the candidate segmentation masks 322. That is, the converted mask level features can be referred to as “mask tokens” that represent or indicate the features of a mask and are able to be utilized by the large language model 316.

In some embodiments, the mask projector model 328 attaches an indicator token (e.g., a special token “<mask_pool_pre>”) to one or more mask tokens projected from the mask features of the digital image 306. For instance, the mask projector model 328 may prepend the indicator token to each projected mask token. The indicator token indicates to the large language model 316 that the next token is a mask token. For example, the mask tokens can be concatenated with other tokens (e.g., the visual tokens 326 and/or the text tokens 324) as inputs to the large language model 316. The indicator token indicates that the corresponding token is a mask token converted from a continuous embedding of a candidate mask, which may enable the large language model 316 to more accurately analyze the mask tokens 320 and select the group of segmentation masks 308.

In some embodiments, the mask projector model 328 receives or identifies a reference mask. In such embodiments, the mask projector model 328 generates mask tokens as described herein for the features of the reference mask. The mask projector model 328 attaches a reference indicator token (e.g., a special token “<mask_ref>”) that indicates to the large language model 316 that the corresponding mask token is a reference mask token. As an illustrative example, the prompt 302 can indicate both a natural language input 304 of “select all objects with the same color as” followed by the reference mask indicated by the client device. Thus, the large language model 316 utilizes the reference mask token(s) generated from the specified reference mask to group candidate segmentation masks 322.

In some embodiments, the reference mask tokens have different associated indicator tokens (e.g., different special tokens) than the candidate mask tokens. For example, the mask projector model 328 prepends a first type of indicator token (e.g., “<mask_pool_pre>”) to indicate that a corresponding mask token will be an embedding for a candidate mask in the pool of segmentation masks 322. The large language model 316 treats such mask tokens as possible choices for the mask grouping task. The mask projector model 328 prepends a second type of indicator token (e.g., “<mask_ref_pre>”) to indicate that the corresponding token will be a reference mask's embedding. The large language model 316 is thus enabled to extract related information (e.g., features of the reference mask to be used as a computer vision criteria) for the mask grouping task.

As shown in FIG. 3, the mask group system 102 also includes visual backbone model(s) 312. Although depicted as a single model for illustrative clarity, the visual backbone model 312 can include a set of visual backbone models (e.g., a single visual backbone model or multiple backbone models such as two backbone models, four backbone models, etc.). A visual backbone model can refer to a neural network that extracts features of input image data and encodes the features into a latent space representation. For example, the visual backbone model can generate a feature map for the digital image 306 (or portions of the digital image 306). A feature map can indicate or be generated based on features such as colors, shapes, textures, or other examples of characteristics and attributes in the image which can be utilized by the mask group system 102 to perform various segmentation tasks. In some examples, the visual backbone model(s) 312 can be referred to as an ensemble of multiple visual backbones (e.g., the visual backbone model includes four backbones such as CLIP, SigLIP, ConvNext-based CLIP, and/or DINOv2). Such an ensemble can provide advantages for the mask group system 102. For example, the ensemble can realize the benefits of the different models (e.g., the ensemble can produce well-localized features for a mask-grouping task compared to a single backbone system).

In some embodiments, the visual backbone model 312 produces features for candidate segmentation masks 322 generated by the segmentation model 310. For example, the visual backbone model 312 performs mask pooling to produce mask-level features from each backbone for the segmentation masks 322. The visual backbone model 312 concatenates (or otherwise combines) the mask-level features along with sinusoidal positional embeddings to produce the final mask features for the segmentation masks 322. In some embodiments, the mask pooling operation is performed for each feature map associated with the segmentation masks 322, which may enable different input resolutions for each visual backbone. Such an architecture can realize the benefits and advantages of each of the different visual backbones.

The mask group system 102 utilizes the visual tokens 326, the mask tokens 320, the text tokens 324, and/or reference mask tokens to select a related group of segmentation masks 308. In some embodiments, the mask group system 102 utilizes the large language model 210 in combination with a binary selection classifier model 318, which can result in improved accuracy, improved training efficiency for the mask group system 102, or both. The binary selection classifier model 318 can be an example of a model as described herein with reference to FIG. 2 (e.g., a classification machine learning model).

To illustrate, the binary selection classifier model 318 makes a binary prediction for each segmentation mask 322 to determine or indicate whether the mask should be included in the group of segmentation masks 308 based on the input mask grouping features (e.g., the grouping features indicated by the text tokens 324, the mask tokens 320, the visual tokens 326, and/or the reference mask tokens). For instance, the mask group system 102 can utilize the large language model 316 to analyze the mask tokens 320 (e.g., in addition to the concatenated mask tokens 320, text tokens 324, visual tokens 326, and reference mask tokens). The large language model 316 generates latent feature vectors for the candidate segmentation masks 322. For example, the large language model 316 captures the final output hidden states for the segmentation masks 322. The binary selection classifier model 318 generates binary predictions (e.g., mask group classification predictions) for the segmentation masks 322 utilizing the outputted hidden states. The binary predictions indicate that a respective mask 322 is included or excluded from the selected group of segmentation masks 308. That is, the mask group system 102 selects candidate segmentation masks 322 having a binary prediction that satisfies a mask group classification threshold (e.g., a binary prediction threshold).

To illustrate, the binary selection classifier model 318 makes a per-mask prediction or decision of whether that mask should be included in the group. For example, in some implementations, the binary selection classifier model 318 generates a prediction (e.g., a probability) that a particular mask is included within the group of masks. The binary selection classifier model 318 compares the prediction to a threshold and determines that a respective mask should (or should not) be included in the group of segmentation masks 308 (e.g., the candidate segmentation mask portrays a dog and is thus included in the group of segmentation masks 308).

In some embodiments, a portion of the mask tokens 320 input to the large language model 316 (e.g., the mask tokens 320 input separate from the other tokens) are fixed to the inputs to the large language model 316 as the mask tokens for decoding. Additionally or alternatively, the large language model 316 uses the last output token as the mask token for decoding. In some embodiments, after mask group decoding (e.g., selection of the group of segmentation masks 308 that satisfy a mask group classification threshold), the large language model 316 generates text tokens as responses to the user input as described herein.

In this manner, the mask group system 102 can select the group of segmentation masks 308 in accordance with natural language features (e.g., features from the language input 304), computer vision features (e.g., a reference mask), both, or an “empty prompt.” To illustrate, the group of segmentation masks 308 includes a first segmentation mask 322 corresponding to a first dog in the digital image 306 and a second segmentation mask 322 corresponding to a second dog in the digital image 306. The mask group system 102 enables the large language model 316 to understand the reference mask and/or the “can you segment the dogs” prompt. Additionally or alternatively, the large language model 316 automatically chooses a group of segmentation masks if no prompt is given by the client device. For instance, the large language model 316 identifies likely desired or reasonable groupings of masks for the digital image 306 (e.g., determining that a quantity of objects correspond to animals and selecting a sub-grouping of the animals accordingly). Thus, the client device can efficiently, accurately, and flexibly indicate a desired selection of one or more masks and the mask group system 102 can output a group of segmentation masks 308 accordingly with relatively little user interaction, latency, or both, among other benefits as described herein.

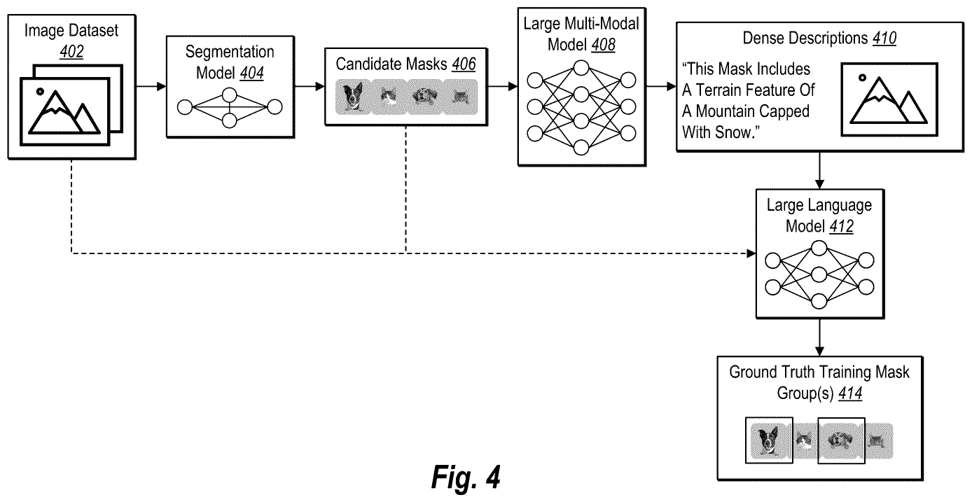

As discussed above, the mask group system 102 can be trained using a training data set. In some embodiments, the mask group system 102 generates the training data set using an automated data pipeline. For instance, FIG. 4 illustrates an annotation pipeline for generating a group mask extraction training dataset in accordance with one or more embodiments. Specifically, FIG. 4 shows the mask group system 102 utilizing an image dataset 402 to generate a training dataset for training the mask group system 102 to perform mask grouping tasks as described herein.

A training dataset can be a dataset used for training one or more models as described herein. For example, the training dataset can be used to train a projector model, large language model and/or binary classification selection model to select groups, for example, by comparing group masks generated during training to the ground truth masks of the training dataset and determining an accuracy of the current set of training parameters (e.g., adjusting the parameters if the accuracy fails to satisfy a threshold). In some examples, the training dataset can be referred to as a group mask extraction training dataset.

For instance, in some implementations, the mask group system 102 generates a training dataset that includes a set of images and, for each image in the set of images, pools of candidate segmentation masks, grouping features (e.g., language and/or computer visions features), ground truth mask groups, and/or language conversations. FIG. 4 illustrates an exemplary automated data annotation pipeline for generating a robust and diverse training dataset capable of training a mask grouping model. As mentioned previously, by generating and utilizing a group mask extraction training dataset utilizing such an annotation pipeline, the mask group system 102 can significantly improve scalability, efficiency, and computer resources for implementing computer devices.

As shown in FIG. 4, the mask group system 102 determines (e.g., receives, identifies, generates) an image dataset 402. The image dataset 402 includes a repository of digital images portraying various entities or objects. The image dataset 402 can include annotated digital images (e.g., digital images corresponding to ground truth candidate masks, mask groups, language conversations, and/or grouping features such as reference masks and language inputs). Additionally or alternatively, the image dataset 402 can include non-annotated digital images (e.g., digital images without corresponding ground truth candidate masks, mask groups, language conversations, and/or grouping features). In some embodiments, the mask group system 102 receives the image dataset from another device or a database.

As illustrated in FIG. 4, in some embodiments, the mask group system 102 filters the image dataset 402. The mask group system 102 can filter the image dataset 402 based on the contents (e.g., entities) in each digital image. For example, the mask group system 102 selects a digital image to include in the image dataset 402 based on a comparison of a quantity of objects in the digital image to a threshold quantity of objects (or by comparing another feature or threshold). To illustrate, the mask group system 102 removes images having a quantity of objects (e.g., annotated or non-annotated objects) that is lower than the threshold quantity of objects. This approach can lead to a training dataset where each digital image corresponds to meaningful mask groups.

As shown, the mask group system 102 generates candidate masks 406 utilizing the segmentation model 404. For example, the mask group system 102 generates a quantity of candidate masks corresponding to a quantity of objects in each digital image of the image dataset 402. In some examples, a digital image may be annotated with ground truth segmentation masks or bounding boxes. In some such examples, the mask group system 102 refines the ground truth segmentation masks or bounding boxes into improved candidate masks 406 for the digital image (e.g., the refined masks can be more precise or accurate). In some examples, the mask group system 102 filters the candidate masks 406. For instance, the mask group system 102 compares ground-truth features (e.g., category labels, attributes, bounding boxes, and/or segmentation masks) of an annotated digital image to the model generated features. The mask group system 102 removes relatively low-quality model generated masks from the training dataset. For example, the mask group system 102 determines that a model-generated candidate mask 406 fails to satisfy a threshold similarity (e.g., pixel overlap, quantity of objects, etc.) to the ground-truth features and excludes the model generated candidate mask 406 from the training dataset based on the failed threshold.

As further illustrated in FIG. 4, the mask group system 102 generates dense descriptions 410 utilizing a large multi-modal model 408. The large multi-modal model 408 can be an example of a model described herein that is capable of processing and understanding information from multiple modalities (e.g., text, images, etc.) such as the various model architectures described herein. The mask group system 102 extracts localized regions (e.g., a local region) of the digital image utilizing the candidate masks 406, for example, as described herein with reference to FIG. 3. The mask group system 102 produces a dense description 410 of a local region (e.g., an area of the digital image corresponding or bounded by the respective candidate mask 406).

To illustrate, the mask group system 102 crops the local region into a sub-image and prompts the large multi-modal model 408 to densely describe the given region. The dense descriptions 410 can include information such as categories, attributes, or other features (e.g., the dense descriptions 410 can be text descriptions indicating features using natural language or text tokens). Stated alternatively, the mask group system 102 generates text descriptions of candidate masks 406 from the localized regions of the digital image. As a merely illustrative example, the dense description 410 for a mask covering a mountain can recite “this mask includes a terrain feature of a mountain capped with snow.” Further, the mask group system 102 can determine positional information (e.g., encoded by the bounding box associated with a mask). Such positional information and/or dense descriptions can represent the corresponding visual entity in natural language terms.

In some examples, the mask group system 102 filters the dense descriptions 410. For instance, the mask group system 102 compares ground-truth text associated with a respective ground-truth mask of an annotated digital image to the model generated dense description 410. The mask group system 102 removes relatively low-quality model generated dense description 410 and/or their corresponding masks or images from the training dataset. For example, the mask group system 102 determines that a model-generated dense description 410 fails to satisfy a threshold similarity to the ground-truth text and excludes the model generated dense description 410 from the training dataset based on the failed threshold. In some examples, the mask group system 102 utilizes a large language model (e.g., the large language model 412) to automatically perform such a comparison and/or removal operation.

In addition, as illustrated in FIG. 4, the mask group system 102 generates ground truth training mask groups 414 utilizing a large language model 412. Ground truth training mask groups 414 can include known or selected groups of candidate masks corresponding to a common feature or class. For example, the training mask groups 414 can include groups of candidate masks 406 that are selected according to one or more natural language and/or computer vision features. The mask group system 102 utilizes the ground truth training mask groups 414 during training to determine and/or improve the accuracy of various models.

For example, the large language model 412 proposes one or more mask groups based on the dense descriptions 410 of the candidate masks 406 for a digital image. Additionally or alternatively, the large language model 412 can propose the mask groups (e.g., the ground truth training mask groups 414) based on the candidate masks 406, the digital image, and/or a reference mask (e.g., using mask tokens, visual tokens, reference mask tokens, and/or text tokens for the dense descriptions 410).

In some embodiments, the mask group system 103 prompts the large language model 412. For example, the mask group system 103 indicates one or more features for selecting the group in the prompt (e.g., introducing the task specifications with a prompt such as “select the masks in this set of masks that have similar attributes”). The mask group system 103 provides examples of mask groups (e.g., by categories, attributes, positions, relations, and/or reference masks) as part of the prompt. The mask group system 103 can also include the dense descriptions 410 to the large language model 412 as part of the prompt. The large language model 412 utilizes the prompt to select the dense descriptions 410 that satisfy the one or more features (e.g., dense descriptions 410 grouped according to text in the descriptions indicating they have a same or similar desired category or attribute).

Thus, the large language model 412 can generate a set of reasonable ground truth training mask groups 414 with diversity. In some examples, the large language model 412 generates text corresponding to the selected mask group. For example, the large language model 412 generates natural language responding to the prompt, explaining the relationship between the selected candidate masks 406 (e.g., the common attribute or other feature), or both.

In some embodiments, the mask group system 102 determines reference masks to include in the training dataset and/or use to generate the training dataset. The training dataset can be constructed with reference masks to improve the accuracy of the mask group system 102 for selecting groups based on reference masks as described herein. In some embodiments, the mask group system 102 generates the training dataset without the reference masks using the data annotation pipeline process illustrated in FIG. 3. The mask group system 102 converts the resulting training dataset to include or support reference masks for training models.

For example, the mask group system 102 can convert category-based and attribute-based groups in the training dataset by using conversations with reference masks like “Select all objects with the same category as <mask_ref>” or “Find all segments with the same color as <mask_ref>,” where <mask_ref> indicates or represents the reference mask. The mask group system 102 can consider positional features by comparing the bounding box coordinates of visual entities. For example, the mask group system 102 can propose groups with a prompt such as “Segment objects to the left side of <mask_ref>.” The mask group system 102 can implement multiple features for groups in a single prompt (e.g., a combination of relative positions and categories). The additional training data generated from reference mask conversion operations can enable the mask group system 102 with the capability to understand mask groups using reference masks.

The mask group system 102 can repeat the operations described in FIG. 4 for each digital image in the image dataset 402. Accordingly, the mask group system 102 generates a group mask extraction training dataset including the image dataset 402, candidate masks 406 (e.g., a pool of candidate masks for each digital image in the image dataset), grouping features (e.g., language and/or computer visions features such as reference masks), ground truth training mask groups 414, and language conversations (e.g., explanations of how the ground truth training mask groups 414 was selected and the relationship between the selected masks).

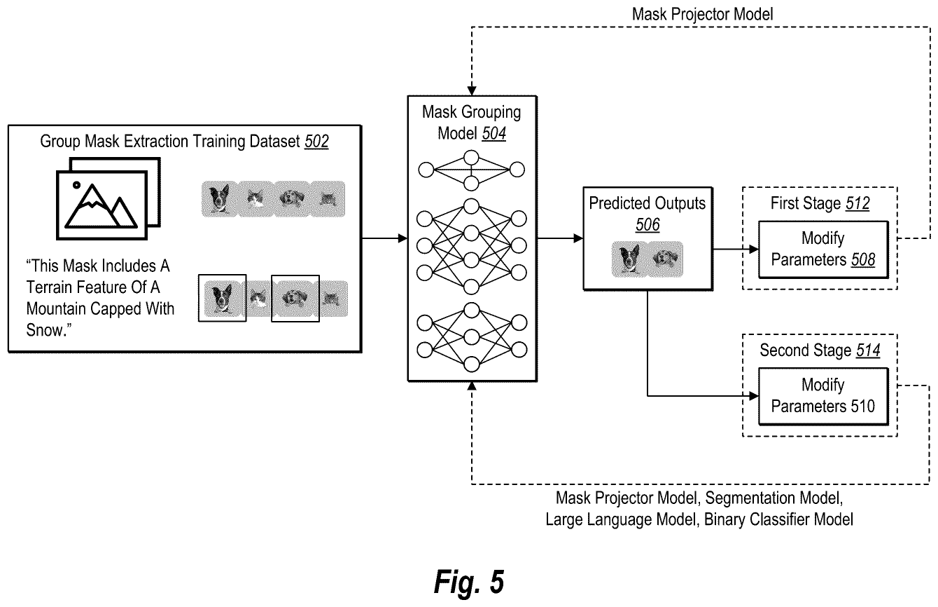

As discussed above, the mask group system 102 trains a mask grouping model using a training data set such as the group mask extraction training dataset described with reference to FIG. 4. As an illustrative example, FIG. 5 shows training a mask grouping model in accordance with one or more embodiments. For instance, FIG. 5 shows the mask group system implementing a two-stage training process for a mask grouping model in accordance with one or more embodiments.

The mask group system 102 trains the mask grouping model 504 utilizing the group mask extraction training dataset 502. The mask grouping model 504 includes one or more of a segmentation model, a visual backbone model (e.g., a visual backbone ensemble), a large language model, a binary selection classifier model, and a mask projector model (e.g., as described in relation to FIG. 3). The group mask extraction training dataset 502 can be an example of a training dataset as described herein with reference to FIG. 4.

In some embodiments, the mask group system 102 trains a model by iteratively adjusting or modifying parameters, weights, or branches of the model until a threshold performance is satisfied. For example, the mask group system 102 configures one or more of the mask grouping model 504 with an initial set of parameters. The mask group system 102 generates predicted outputs 506 (e.g., segmentation masks, mask groups, explanations, etc.) utilizing the mask grouping model 504 having the initial set of parameters. For example, as described in relation to FIG. 3, the mask group system 102 utilizes visual backbone model(s), a segmentation model, a mask projector model, a text tokenizer, a large language model, and/or a binary selection classification model to generate a group of segmentation masks (and/or client response text). Specifically, the mask group system 102 generate a group of segmentation masks (and/or client response text) based on a training digital image, a training resource mask, and/or a training natural language input.

The mask group system 102 trains the mask grouping model 504 by comparing the predicted outputs 506 to a training set of outputs (e.g., various ground truth examples). For example, the mask group system 102 compares the model generated mask group (or other outputs 506) for a training image in the group mask extraction training dataset 502 to the ground truth mask group (or other outputs) corresponding to the training image in the group mask extraction training dataset 502. The mask group system 102 determines a measure of loss based on the comparison. For example, the mask group system 102 can utilize a loss function (e.g., cross-entropy loss, binary cross-entropy loss, hinge loss, KL divergence, focal loss, or dice loss) to determine a measure of loss between the predicted outputs 506 and ground truth from the group mask extraction training dataset 502. The mask group system 102 can adjust the parameters of the mask grouping model 504 (e.g., mask projector model, segmentation model, text tokenizer, large language model, and/or binary selection classifier model) to reduce the measure of loss. Moreover, the mask group system 102 can iteratively repeat such a training process until, for example, satisfying a threshold accuracy or a threshold number of iterations. In this manner, the mask group system 102 can train the mask grouping model 504 to generate groups of segmentation masks and/or client text responses.

In some embodiments, the mask group system 102 trains the mask grouping model 504 in a two-stage training process. The first stage 512 may be referred to as a pre-training stage or a pre-training task. The second stage 514 may be referred to as an instruction tuning stage or task. In some examples, the stages can train different portions of the mask grouping model 504. For example, as shown in FIG. 5, in the first stage 512 the mask group system 102 trains a first portion of the mask grouping model 504 including a mask projector model (e.g., the mask projector model 328). In the second stage 514 the mask group system 102 trains a second portion of the mask grouping model 504 including the mask projector model, a segmentation model (e.g., the segmentation model 310), a large language model (e.g., the large language model 316), and a binary selection classifier model (e.g., the binary selection classifier model 318). While described in the example of FIG. 5 as a two-stage training process, the mask group system 102 can utilize a different quantity or type of stages that train different groups of models.

As shown in FIG. 5, the mask group system 102 performs the first stage 512. In the first stage 512, the mask group system 102 trains a first portion of the mask grouping model 504 (e.g., the mask projector model). For instance, the mask group system 102 freezes other algorithms of the mask grouping model 504. Stated alternatively, the mask group system 102 maintains the state or value of parameters for the mask grouping model 504 that are not being trained in the first stage (e.g., the parameters 510 for models other than the mask projector model retain their states while the parameters 508 corresponding to the mask projector model are trained).

For example, in some implementations the first stage 512 utilizes a relatively smaller portion of the group mask extraction training dataset 502 compared to the second stage 514. To illustrate, the mask grouping model 504 generates an image-level description (e.g., dense descriptions for each of the candidate masks in a digital image) utilizing the set of digital images, candidate segmentation masks, and detailed descriptions associated with the candidate segmentation masks from the group mask extraction training dataset 502. In some embodiments, in the first stage 512, the mask grouping model 504 generates predicted outputs 506 utilizing mask tokens associated with the training segmentation masks. In such embodiments, the predicted outputs 506 include an image-level description. The mask group system 102 iteratively compares the predicted outputs 506 to the ground truth image-level descriptions (i.e., image-level captions, set of dense descriptions corresponding to a digital image) and modifies parameters 508 of the mask projector model based on the comparison. In some examples, the mask group system 102 enforces the mask projector model to align mask features with the large language model utilizing the first stage 512.

As shown in FIG. 5, the mask group system 102 also performs the second stage 514. In the second stage 514, the mask group system 102 trains a second portion of mask grouping model 504 with initial parameters including the parameters 508 of the trained first portion of mask grouping model 504. To illustrate, the initial parameters for the second training stage of the mask projector model can be the tuned parameters from the first stage 512. The second portion of the mask grouping model 504 can include the mask projector model, the segmentation model, the large language model, and the binary selection classifier model. That is, the parameters 510 modified during the second training stage correspond to the parameters of the second portion of mask grouping model 504. In some embodiments, the mask group system 102 freezes the visual backbone model(s) parameters during both training stages.

To illustrate, the mask grouping model 504 generates predicted outputs 506 that include a predicted mask group and/or a predicted client response text for each digital image in the group mask extraction training dataset 502. The mask group system 102 iteratively compares the predicted outputs 506 to the corresponding ground truth data (e.g., the ground truth mask groups, client response text) and modifies parameters 510 of the second portion of mask grouping model 504 based on the comparison. Thus, in the second training stage, multiple modules (e.g., each of the mask grouping model 504 except the visual backbone models) can be tuned together for the mask grouping tasks described herein.

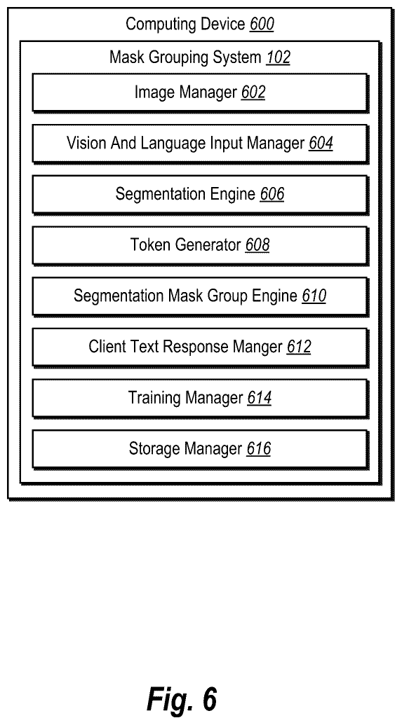

FIG. 6 illustrates a schematic diagram of an embodiment of the mask group system 102 described above. As shown, the mask group system 102 is implemented on computing device(s) 600 (e.g., a client device and/or server device as described in FIG. 1, and as further described below in relation to FIG. 8). Additionally, the mask group system 102 includes, but is not limited to, an image manager 602, a vision and language input manager 604, segmentation engine 606, a token generator 608, a segmentation mask group engine 610, a client text response manager 612, a training manager 614, and a storage manager 616. In one or more embodiments, the mask group system 102 is implemented on any number of computing devices. For example, the mask group system 102, in one or more embodiments, is implemented in a distributed system of server devices for digital image generation. Alternatively, the mask group system 102 is also implemented within one or more additional systems. For example, the mask group system 102, in one or more embodiments, is implemented on a single computing device such as a single client device.

Each of the components of the mask group system 102 can include software, hardware, or both. For example, the components 602-606 can include one or more instructions stored on a computer-readable storage medium and executable by processors of one or more computing devices, such as a client device or server device. When executed by the one or more processors, the computer-executable instructions of the mask group system 102 can cause the computing device(s) to perform the methods described herein. Alternatively, the components 602-606 can include hardware, such as a special-purpose processing device to perform a certain function or group of functions. Alternatively, the components of the mask group system 102 can include a combination of computer-executable instructions and hardware.

Furthermore, the components of the mask group system 102 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 602-606 may be implemented as a stand-alone application, such as a desktop or mobile application. Furthermore, the components 602-606 may be implemented as one or more web-based applications hosted on a remote server. The components 602-606 may also be implemented in a suite of mobile device applications or “apps.” To illustrate, the components 602-606 may be implemented in an application, that provides digital editing, including, but not limited to ADOBE® PHOTOSHOP® and ADOBE® CREATIVE CLOUD® software.

As illustrated, the mask group system 102 includes an image manager 602 to access, generate, retrieve, identify, provide, and/or manage digital images for image editing operations. In particular, the image manager 1202 accesses digital images for editing based on user inputs providing the digital images or accessing the digital images from a database of images. Additionally, the image manager 1202 manages providing mask groups for display.

Additionally, the mask group system 102 includes a vision and language input manager 604. The vision and language input manager 604 can access, receive, identify, and/or manage various inputs (e.g., from a client device). For example, as described in greater detail above, the vision and language input manager 604 can receive vision inputs (e.g., selection of a portion of an image such as a reference mask) and/or language inputs (e.g., a query text indicating a particular group to segment from a digital image).

In addition, the mask group system 102 includes a segmentation engine 606. The segmentation engine 606 can generate, create, and/or identify segmentation masks from a digital image. As discussed above, the segmentation engine 606 can utilize a segmentation model to extract candidate segmentation masks from a digital image.

Moreover, the mask group system 102 includes a token generator 608. The token generator 608 can create and/or generate tokens for utilization by a large language model. For example, as described above the token generator 608 can generate mask tokens (e.g., utilizing a visual backbone model and/or mask projector model) and/or text tokens (e.g., utilizing a text tokenizer).

As shown in FIG. 6, the mask group system 102 also includes segmentation mask group engine 610. For example, the segmentation mask group engine can generate, create, extract, and/or identify a group of related segmentation masks from a digital image (e.g., based on tokens from the token generator 608). For example, as discussed above, the segmentation mask group engine 610 can utilize a large language model to analyze tokens and generate latent feature vectors. The segmentation mask group engine 610 can then utilize a classification model to analyze the latent feature vectors and identify masks to include in a group of segmentation masks to surface to a client device.

The mask group system 102 also includes a client text response manager 612. The client text response manager 612 can generate and/or create a client text response (e.g., for a client device). As discussed above, the client text response manager 612 can utilize a large language model to analyze tokens (e.g., from the token generator 608) and generate a client text response corresponding to a group of segmentation masks.

Further, the mask group system 102 includes a training manager 606. The training manager 606 trains, tunes, and/or learns parameters for one or more machine learning models, including components of a mask grouping model, as described herein. For example, the training manager 606 can perform a two-stage training process as described above with reference to FIG. 5, among other examples of training operations. Additionally or alternatively, the training manager 606 generates a training dataset. For example, the training manager 606 can implement the data annotation pipeline described with reference to FIG. 4 to generate a group mask extraction training dataset for use in training the one or more models.

As shown, the mask group system 102 also includes a storage manager 616. The storage manager 616 can store, maintain, and/or retrieve data for the mask group system 102 (e.g., via one or more storage devices). For example, the storage manager 616 can store digital images, candidate segmentation masks, groups of segmentation masks, language input, reference masks, client text responses, and/or various parameters of a mask grouping model.

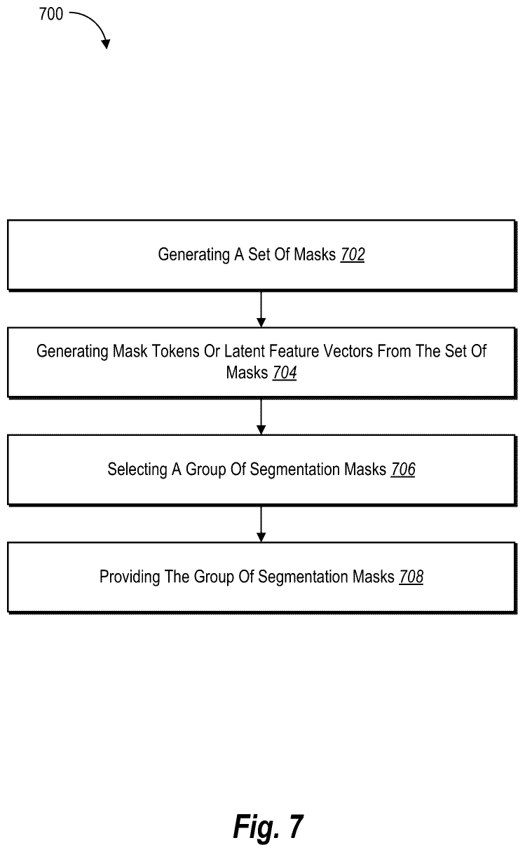

FIG. 1-6, the corresponding text, and the examples provide a number of different methods, systems, devices, and non-transitory computer-readable media of the mask group system 102. In addition to the foregoing, one or more embodiments can also be described in terms of flowcharts comprising acts for accomplishing a particular result, as shown in FIG. 7. FIG. 7 may be performed with more or fewer acts. Further, the acts may be performed in differing orders. Additionally, the acts described herein may be repeated or performed in parallel with one another or parallel with different instances of the same or similar acts.

As mentioned, FIG. 7 illustrates a flowchart of a series of acts 700 for grouping segmentation masks in accordance with one or more embodiments. While FIG. 7 illustrates acts according to one embodiment, alternative embodiments may omit, add to, reorder, and/or modify any of the acts shown in FIG. 7. The acts of FIG. 7 can be performed as part of a method. Alternatively, a non-transitory computer-readable medium can comprise instructions that, when executed by one or more processors, cause a computing device to perform the acts of FIG. 7. In some embodiments, a system can perform the acts of FIG. 7.

As shown in FIG. 7, the series of acts 700 includes an act 702 of generating a set of candidate segmentation masks, an act 704 of generating mask tokens and/or latent feature vectors from the set of masks, an act 706 of selecting a group of segmentation masks, and an act 708 of providing the group of segmentation masks.

In particular, the act 702 can include generating, utilizing a segmentation model, a set of candidate segmentation masks for objects portrayed in a digital image. Additionally or alternatively, the act 702 can include generating, utilizing a segmentation model, candidate segmentation masks for objects portrayed in a digital image.

The act 704 can include generating, utilizing a mask projector model, a set of mask tokens from the set of candidate segmentation masks. Additionally or alternatively, the act 704 can include generating, utilizing a large language model, latent feature vectors for the candidate segmentation masks. In one or more embodiments, the series of acts 700 includes generating, utilizing a classification machine learning model, group classification predictions for the candidate segmentation masks from the latent feature vectors.

The act 706 can include selecting, utilizing a large language model, a group of segmentation masks from the set of candidate segmentation masks based on the set of mask tokens, where the group of segmentation masks satisfy a mask group classification threshold. Additionally or alternatively, the act 706 can include selecting a group of segmentation masks for the digital image based on the group classification predictions for the candidate segmentation masks. The act 708 can include providing, for display via a client device, the group of segmentation masks for the digital image.

In one or more embodiments, the series of acts 700 includes receiving, from the client device, a reference mask. The series of acts 700 further includes generating, utilizing the mask projector model, a reference mask token from the reference mask. The series of acts 700 further includes selecting, utilizing the large language model, the group of segmentation masks from the set of candidate segmentation masks based on the reference mask token and the set of mask tokens.

In one or more embodiments, the series of acts 700 includes receiving, from the client device, language input corresponding to the digital image. The series of acts 700 further includes generating, utilizing a text tokenizer, a set of text tokens associated with the language input from the client device. The series of acts 700 further includes selecting, utilizing the large language model, the group of segmentation masks based on the set of text tokens and the set of mask tokens.

In one or more embodiments, the series of acts 700 includes generating, utilizing a plurality of visual backbone models, a set of global visual tokens associated with the digital image. The series of acts 700 further includes selecting, utilizing the large language model, the group of segmentation masks based on the set of global visual tokens and the set of mask tokens.

In one or more embodiments, the series of acts 700 includes generating, utilizing a plurality of visual backbone models, a localized candidate mask feature map for the candidate mask from the digital image. The series of acts 700 further includes converting, utilizing the mask projector model, the localized candidate mask feature map for the candidate mask into a mask token for the candidate mask.

In one or more embodiments, the series of acts 700 includes generating, utilizing a classification machine learning model, a mask group classification probability prediction from a mask token corresponding to a candidate segmentation mask of the set of candidate segmentation masks. The series of acts 700 further includes selecting the candidate segmentation mask for the group of segmentation masks by comparing the mask group classification probability prediction to the mask group classification threshold.

In one or more embodiments, the series of acts 700 includes generating, utilizing the large language model, client response text based on the set of mask tokens. The series of acts 700 further includes providing, for display via the client device, the client response text and the group of segmentation masks.

In one or more embodiments, the series of acts 700 includes generating a group mask extraction training dataset comprising a training image, training candidate masks for the training image, a ground truth training mask group for the training image, and training text descriptions corresponding to training candidate masks. The series of acts 700 further includes training the large language model to generate mask groups for individual digital images utilizing the group mask extraction training dataset.

In one or more embodiments, the series of acts 700 includes extracting localized regions of the training image utilizing the training candidate masks. The series of acts 700 further includes generating, utilizing one or more large language models, the training text descriptions of the training candidate masks from the localized regions of the training image. The series of acts 700 further includes generating, utilizing at least one large language model, the ground truth training mask group for the training image from the training text descriptions and the training candidate masks. In one or more embodiments, the series of acts 700 includes training the large language model by comparing the group of segmentation masks to a ground truth mask group for the digital image.

In one or more embodiments, the series of acts 700 includes extracting localized regions of the digital image utilizing the candidate segmentation masks. The series of acts 700 further includes generating, utilizing one or more large language models, text descriptions of the candidate segmentation masks from the localized regions of the digital image. The series of acts 700 further includes generating, utilizing at least one large language model, the ground truth mask group for the digital image from the text descriptions and the candidate segmentation masks.

In one or more embodiments, the series of acts 700 includes selecting the digital image to include in a group mask extraction training dataset for training the large language model based on comparing a quantity of the objects portrayed in the digital image with an object quantity threshold. In one or more embodiments, the series of acts 700 includes providing, for display via a client device, the group of segmentation masks for the digital image.

In one or more embodiments, the series of acts 700 includes receiving at least one of a reference mask or a language input corresponding to the digital image. The series of acts 700 further includes generating one or more sets of tokens based on at least one of the reference mask or the language input. The series of acts 700 further includes generating the group classification predictions based on the one or more sets of tokens. In one or more embodiments, the one or more sets of tokens comprises at least one of a set of text tokens, a set of mask tokens, or a set of global visual tokens.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 8 illustrates a block diagram of an example computing device 800 that may be configured to perform one or more of the processes described above. One will appreciate that one or more computing devices, such as the computing device 800 may represent the computing devices described above (e.g., client device 106, server device 104). In one or more embodiments, the computing device 800 may be a mobile device (e.g., a mobile telephone, a smartphone, a PDA, a tablet, a laptop, a camera, a tracker, a watch, a wearable device, etc.). In some embodiments, the computing device 800 may be a non-mobile device (e.g., a desktop computer or another type of client device). Further, the computing device 800 may be a server device that includes cloud-based processing and storage capabilities.

As shown in FIG. 8, the computing device 800 can include one or more processor(s) 802, memory 804, a storage device 806, input/output interfaces 808 (or “I/O interfaces 808”), and a communication interface 810, which may be communicatively coupled by way of a communication infrastructure (e.g., bus 812). While the computing device 800 is shown in FIG. 8, the components illustrated in FIG. 8 are not intended to be limiting. Additional or alternative components may be used in other embodiments. Furthermore, in certain embodiments, the computing device 800 includes fewer components than those shown in FIG. 8. Components of the computing device 800 shown in FIG. 8 will now be described in additional detail.

In particular embodiments, the processor(s) 802 includes hardware for executing instructions, such as those making up a computer program. As an example, and not by way of limitation, to execute instructions, the processor(s) 802 may retrieve (or fetch) the instructions from an internal register, an internal cache, memory 804, or a storage device 806 and decode and execute them.

The computing device 800 includes memory 804, which is coupled to the processor(s) 802. The memory 804 may be used for storing data, metadata, and programs for execution by the processor(s). The memory 804 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 804 may be internal or distributed memory.

The computing device 800 includes a storage device 806 includes storage for storing data or instructions. As an example, and not by way of limitation, the storage device 806 can include a non-transitory storage medium described above. The storage device 806 may include a hard disk drive (HDD), flash memory, a Universal Serial Bus (USB) drive or a combination these or other storage devices.

As shown, the computing device 800 includes one or more I/O interfaces 808, which are provided to allow a user to provide input to (such as user strokes), receive output from, and otherwise transfer data to and from the computing device 800. These I/O interfaces 808 may include a mouse, keypad or a keyboard, a touch screen, camera, optical scanner, network interface, modem, other known I/O devices or a combination of such I/O interfaces 808. The touch screen may be activated with a stylus or a finger.

The I/O interfaces 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 808 are configured to provide graphical data to a display for presentation to a user. The graphical data may be representative of one or more graphical user interfaces and/or any other graphical content as may serve a particular implementation.

The computing device 800 can further include a communication interface 810. The communication interface 810 can include hardware, software, or both. The communication interface 810 provides one or more interfaces for communication (such as, for example, packet-based communication) between the computing device and one or more other computing devices or one or more networks. As an example, and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI. The computing device 800 can further include a bus 812. The bus 812 can include hardware, software, or both that connects components of computing device 800 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
generating, utilizing a segmentation model, a set of candidate segmentation masks for objects portrayed in a digital image;
generating, utilizing a mask projector model, a set of mask tokens from the set of candidate segmentation masks;
selecting, utilizing a large language model, a group of segmentation masks from the set of candidate segmentation masks based on the set of mask tokens, wherein the group of segmentation masks satisfy a mask group classification threshold; and
providing, for display via a client device, the group of segmentation masks for the digital image.

2. The computer-implemented method of claim 1, further comprising:
receiving, from the client device, a reference mask;
generating, utilizing the mask projector model, a reference mask token from the reference mask; and
selecting, utilizing the large language model, the group of segmentation masks from the set of candidate segmentation masks based on the reference mask token and the set of mask tokens.

3. The computer-implemented method of claim 1, further comprising:
receiving, from the client device, language input corresponding to the digital image;
generating, utilizing a text tokenizer, a set of text tokens associated with the language input from the client device; and
selecting, utilizing the large language model, the group of segmentation masks based on the set of text tokens and the set of mask tokens.

4. The computer-implemented method of claim 1, further comprising:
generating, utilizing a plurality of visual backbone models, a set of global visual tokens associated with the digital image; and
selecting, utilizing the large language model, the group of segmentation masks based on the set of global visual tokens and the set of mask tokens.

5. The computer-implemented method of claim 1, wherein generating the set of mask tokens comprises, for a candidate mask of the set of candidate segmentation masks:
generating, utilizing a plurality of visual backbone models, a localized candidate mask feature map for the candidate mask from the digital image; and
converting, utilizing the mask projector model, the localized candidate mask feature map for the candidate mask into a mask token for the candidate mask.

6. The computer-implemented method of claim 1, wherein selecting the group of segmentation masks comprises:
generating, utilizing a classification machine learning model, a mask group classification probability prediction from a mask token corresponding to a candidate segmentation mask of the set of candidate segmentation masks; and
selecting the candidate segmentation mask for the group of segmentation masks by comparing the mask group classification probability prediction to the mask group classification threshold.

7. The computer-implemented method of claim 1, further comprising:
generating, utilizing the large language model, client response text based on the set of mask tokens; and
providing, for display via the client device, the client response text and the group of segmentation masks.

8. The computer-implemented method of claim 1, further comprising:
generating a group mask extraction training dataset comprising a training image, training candidate masks for the training image, a ground truth training mask group for the training image, and training text descriptions corresponding to training candidate masks; and
training the large language model to generate mask groups for individual digital images utilizing the group mask extraction training dataset.

9. The computer-implemented method of claim 8, wherein generating the group mask extraction training dataset comprises:
extracting localized regions of the training image utilizing the training candidate masks;
generating, utilizing one or more large language models, the training text descriptions of the training candidate masks from the localized regions of the training image; and
generating, utilizing at least one large language model, the ground truth training mask group for the training image from the training text descriptions and the training candidate masks.

10. A system comprising:
one or more memory devices; and
one or more processors coupled to the one or more memory devices that cause the system to perform operations comprising:
generating, utilizing a segmentation model, candidate segmentation masks for objects portrayed in a digital image;
generating, utilizing a large language model, latent feature vectors for the candidate segmentation masks;
generating, utilizing a classification machine learning model, group classification predictions for the candidate segmentation masks from the latent feature vectors; and
selecting a group of segmentation masks for the digital image based on the group classification predictions for the candidate segmentation masks.

11. The system of claim 10, wherein the operations further comprise:
training the large language model by comparing the group of segmentation masks to a ground truth mask group for the digital image.

12. The system of claim 11, wherein the operations further comprise generating the ground truth mask group by:
extracting localized regions of the digital image utilizing the candidate segmentation masks;
generating, utilizing one or more large language models, text descriptions of the candidate segmentation masks from the localized regions of the digital image; and
generating, utilizing at least one large language model, the ground truth mask group for the digital image from the text descriptions and the candidate segmentation masks.

13. The system of claim 12, wherein the operations further comprise selecting the digital image to include in a group mask extraction training dataset for training the large language model based on comparing a quantity of the objects portrayed in the digital image with an object quantity threshold.

14. The system of claim 10, wherein the operations further comprise providing, for display via a client device, the group of segmentation masks for the digital image.

15. The system of claim 10, wherein the operations further comprise:
receiving at least one of a reference mask or a language input corresponding to the digital image;
generating one or more sets of tokens based on at least one of the reference mask or the language input; and
generating the group classification predictions based on the one or more sets of tokens.

16. The system of claim 15, wherein the one or more sets of tokens comprises at least one of a set of text tokens, a set of mask tokens, or a set of global visual tokens.

17. A non-transitory computer-readable medium storing instructions thereon that, when executed by at least one processor, cause the at least one processor to perform operations comprising:
generating, utilizing a segmentation model, a set of candidate segmentation masks for objects portrayed in a digital image;
generating, utilizing a mask projector model, a set of mask tokens from the set of candidate segmentation masks;
selecting, utilizing a large language model, a group of segmentation masks from the set of candidate segmentation masks based on the set of mask tokens, wherein the group of segmentation masks satisfy a mask group classification threshold; and
providing, for display via a client device, the group of segmentation masks for the digital image.

18. The non-transitory computer-readable medium of claim 17, wherein the operations further comprise:
generating, utilizing the mask projector model, a reference mask token from a reference mask; and
selecting, utilizing the large language model, the group of segmentation masks from the set of candidate segmentation masks based on the reference mask token and the set of mask tokens.

19. The non-transitory computer-readable medium of claim 17, wherein the operations further comprise:
receiving, from the client device, language input corresponding to the digital image;
generating a set of text tokens associated with the language input from the client device; and
selecting, utilizing the large language model, the group of segmentation masks based on the set of text tokens and the set of mask tokens.

20. The non-transitory computer-readable medium of claim 17, wherein generating the set of mask tokens comprises, for a candidate mask of the set of candidate segmentation masks:
generating, utilizing a visual backbone model, a localized candidate mask feature map for the candidate mask from the digital image; and
converting, utilizing the mask projector model, the localized candidate mask feature map for the candidate mask into a mask token for the candidate mask.
